(19) United States
(12) Patent Application Publication
(10) Pub. No.: US 2026/0058450 A1
(43) Pub. Date: Feb. 26, 2026

(54) DEVICE BOX WITH DETACHABLE BACK

(71) Applicants: RICHARD TEMBLADOR, CLARKS SUMMIT, PA (US); STEVE FINNERTY, South Abingdon Township, PA (US)

(72) Inventors: RICHARD TEMBLADOR, CLARKS SUMMIT, PA (US); STEVE FINNERTY, South Abingdon Township, PA (US)

(21) Appl. No.: 19/019,385

(22) Filed: Jan. 13, 2025

(51) Int. Cl. H02G 3/08; H02G 3/14

(52) U.S. Cl. CPC H02G 3/081; H02G 3/14

(57) ABSTRACT

A non-metallic device box with a detachable back. The device box includes four side walls and a detachable back wall. The side walls terminate in a planar front edge defining a front opening. Component bosses extend inwards from two of the opposing side walls and include front surfaces that are planar with the front edge. A first of the side walls includes an opening with a removable panel that includes one or more bosses with captive screws for securing the device box to a stud or similar structural support. The detachable back may be slid into interlocking engagement with tabs on a first of the sidewalls. The device box may include a screw-detachable back or a snap-detachable back, making wiring connections much easier to accomplish when the back of the box is available prior to drywall installation rather than having to wire conventionally through the drywall cut-out opening.

### BACKGROUND OF THE INVENTION

Although various device boxes have been proposed for mounting of devices, such as electrical components and low voltage devices, conventional device boxes typically include only one opening for insertion of a device. Thus electrical contractors have limited access and flexibility for installation of a device into the box. The few commercial device boxes with removable backs are typically metallic boxes.

A key benefit for this detachable back non-metallic box is the ability to access the wiring from the back when pre-installing wiring devices. Wire connections or make-up is much easier to accomplish when the back of the box is available prior to drywall installation rather than having to wire conventionally through the drywall cut-out opening.

Thus it would be advantageous to provide a non-metallic box with improved access for installing a device into the box.

### BRIEF SUMMARY OF THE INVENTION

The invention is a device box with a detachable back. The device box includes four side walls and a detachable back wall. The side walls terminate in a planar front edge defining a front opening. Component bosses extend inwards from two of the opposing side walls and include front surfaces that are planar with the front edge. A first of the side walls includes an opening with a removable panel that includes one or more bosses with captive screws for securing the device box to a stud or similar structural support. The bosses position the screws at an angle that enables the installer to drive the captive screws into the support. Tabs on the first side wall enable sliding of the removable panel into the opening in the side wall. A boss on one of the side edges includes an aperture therein. The detachable back is substantially planar with two side edges. A first edge of the detachable back includes one or more recesses and the opposing edge includes a slot therein. The detachable back may be slid into interlocking engagement with tabs on one of the sidewalls and a screw may be used to secure the detachable back to the sidewalls of the device box thereby creating an electrical enclosure within the box.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a front perspective view of a first embodiment of a device box with a screw detachable back according to the invention.

FIG. 2 is a rear perspective view of the device box with a screw to secure the back panel to the main portion of the box.

FIG. 3 is a rear perspective view of the fully assembled device box.

FIG. 4 is a front perspective view of a second embodiment of a device box with a snap detachable back according to the invention.

FIG. 5 is a rear perspective view of the second embodiment of the device box with a cantilever snap-fit to secure the back panel to the main portion of the box.

FIG. 6 is a rear perspective view of the fully assembled second embodiment of the device box.

FIG. 7 is a front view of the first embodiment of the device box with a screw detachable back according to the invention.

FIG. 8 is a sectional view of the first embodiment of the device box taken along line 8-8 of FIG. 7.

FIG. 9 is a rear view of the of the first embodiment of the device box.

FIG. 10 is a side view of the first embodiment of the device box as viewed from the right side of FIG. 9.

FIG. 11 is an end view of the first embodiment of the device box.

FIG. 12 is a is a side view of the first embodiment of the device box as viewed from the left side of FIG. 9.

FIG. 13 is a front view of the second embodiment of the device box with a screw detachable back according to the invention.

FIG. 14 is a sectional view of the second embodiment of the device box taken along line 14-14 of FIG. 13.

FIG. 15 is a rear view of the of the second embodiment of the device box.

FIG. 16 is a side view of the second embodiment of the device box as viewed from the right side of FIG. 15.

FIG. 17 is an end view of the second embodiment of the device box.

FIG. 18 is a is a side view of the second embodiment of the device box as viewed from the left side of FIG. 15.

FIG. 19 is an isometric view of the outer side of a detachable back wall according to the invention.

FIG. 20 is an isometric view of the inner side of the detachable back wall.

FIG. 21 is an isometric view of a third embodiment of the device box.

### DETAILED DESCRIPTION OF THE INVENTION

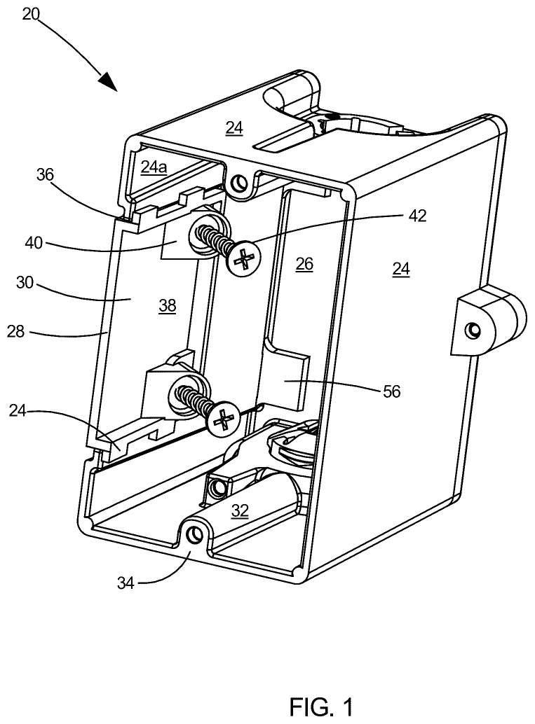

With reference to FIGS. 1-3, the current invention is a non-metallic device box 20 with a detachable back for providing enhanced access to the wiring cavity of the box. The device box includes four side walls 24 and a detachable back wall 26. The side walls 24 terminate in a planar front edge 28 defining a front opening 30. Component bosses 32 are included on two of the opposing side walls 24. The component bosses 32 include front surfaces 34 that are planar with the planar front edge 28. A first 24a of the side walls includes a side opening 36 with a removable panel 38 that includes one or more bosses 40 with captive screws 42 for securing the device box 20 to a stud or similar structural support.

As shown in FIG. 8, the bosses 40 position the screws at an angle with respect to the side walls 24 that enables the installer to easily a access the captive screws 42 and drive them into the support. Tabs 44 on the first side wall 24a enable sliding of the removable panel 38 into the opening 36 in the first side wall 24a.

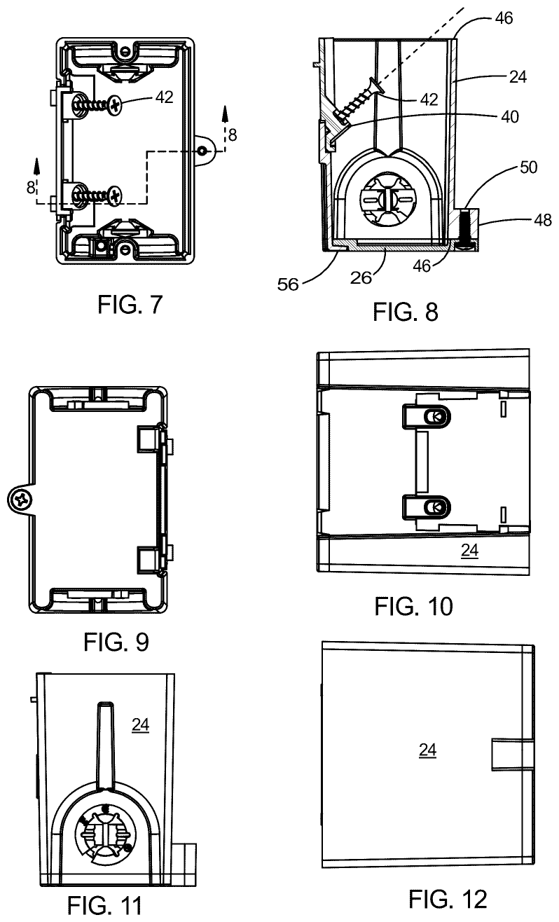

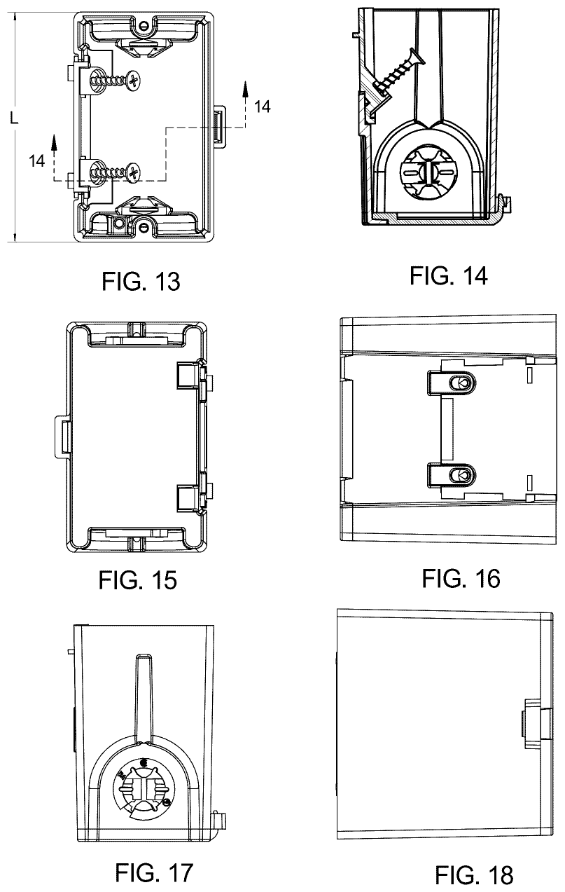

With reference to FIGS. 7-12 wherein parts in common with the first embodiment include the same reference numerals, the side walls 24 include rear edges 46. A boss 48 is located on one side wall 24 adjacent the rear edge 46 and includes a bore 50 therein. The detachable back is substantially planar with the rear edges 46 of the side walls 24.

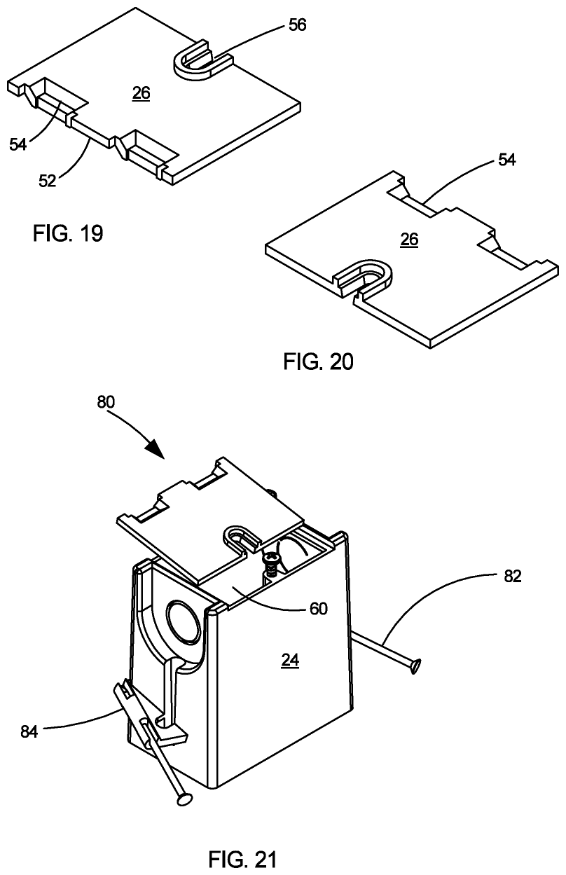

Referring to FIGS. 19-20, a first edge 52 of the detachable back includes one or more recesses 54 and the opposing edge includes a slot 54 therein. The detachable back 26 may be slid into interlocking engagement with tabs 56 on one of the sidewalls and a screw 58 may be used to secure the detachable back 26 to the side walls 24 of the device box thereby creating an electrical enclosure 60 within the box.

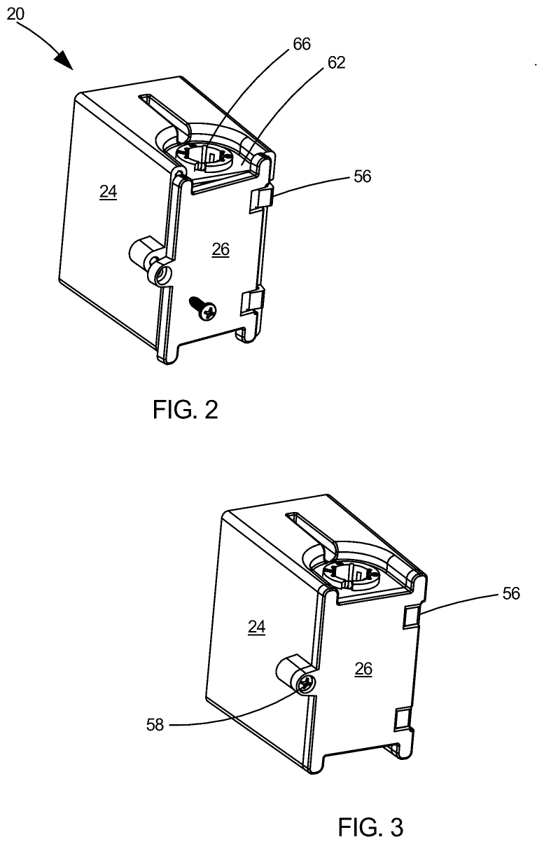

With reference to FIGS. 2-3, recessed areas 62 provided on one or more of the side walls 24 include knockout apertures 64 therein and an electrical fitting 66 for passing electrical cable (not shown) into the wiring cavity or enclosure.

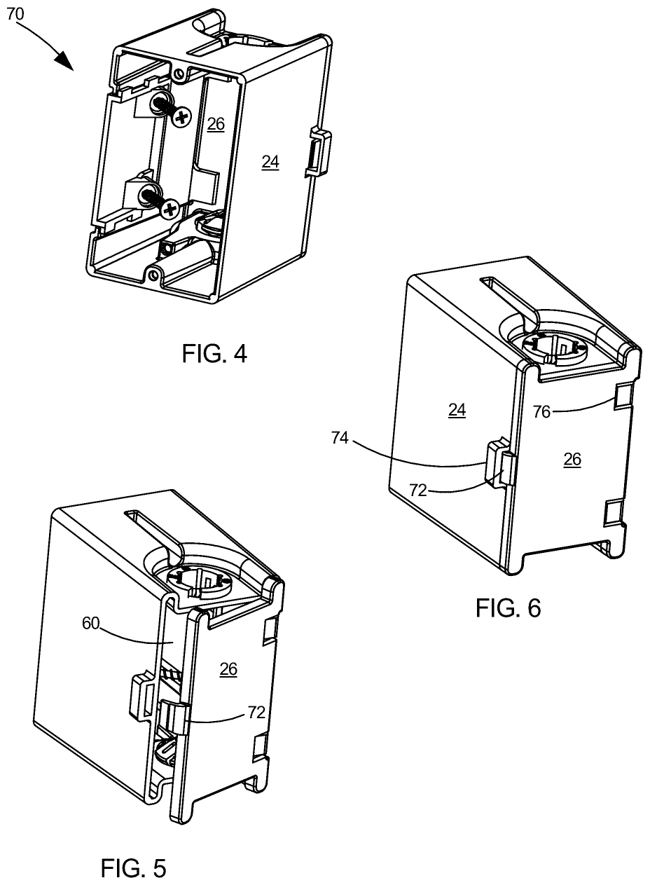

Referring to FIGS. 4-6, the second embodiment of the device box 70 is substantially similar to the first embodiment except the detachable back 26 is attached by snap engagement rather than screw attachment. The detachable back 26 includes a closure tab 72 and the side wall 24 include a latch 74 for engaging the tab 72 when the back is closed onto the side walls as shown in FIG. 6.

With reference to FIG. 19, one end 74 of the detachable back 26 includes one or more tabs 76 that are capable of sliding engagement with the tabs 56 on one of the sidewalls 24, after which screw 58 (see FIG. 21) or closure tab 72 and latch 74 (see FIG. 5) may be used to secure the detachable back 26 to the side walls 24 of the device box thereby creating an electrical enclosure 60 within the box.

With reference to FIG. 21, a third embodiment of the device box 80 includes captive nails 82 held within nail mounts 84 on one or more side walls 24. The captive nails 82 can be driven into a suitable support and the wiring cavity 60 can be accessed from either the front or back of the box.

The device box of the present invention is non-metallic, preferably molded of plastic.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments while realizing that various modifications may be made to suit the particular use contemplated.

I claim:

1. A device box, comprising:
four side walls;
a detachable back wall; and
a closure mechanism for securing the detachable back wall to one or more of the side walls.

2. The device box of claim 1, comprising:
a front opening; and
a planar front edge on said side walls.

3. The device box of claim 2, comprising:
a component boss on said side wall; and
a front surface on said component boss.

4. The device box of claim 3, comprising said front surface on said component boss is planar with the planar front edge of said side walls.

5. The device box of claim 4, comprising:
an opening in a first of said side walls; and
a removable panel on the first of said side walls.

6. The device box of claim 5, comprising a boss on said removable panel.

7. The device box of claim 1, wherein said closure mechanism comprises:
a boss on one of said side walls;
a tab on said detachable back wall; and
a screw through said tab and into said boss on said one of said side walls.

8. The device box of claim 5, wherein said closure mechanism comprises:
a tab on the detachable back wall; and
a latch on one of said side walls for engaging the tab.

9. The device box of claim 5, comprising:
one or more tabs on said side walls; and
one or more tabs on said detachable back.

10. The device box of claim 5, comprising:
one or more recessed area on said side walls; and
a knockout aperture in said recessed area.

11. The device box of claim 10, comprising an electrical fitting installed in said knockout aperture.
